(19) United States
(12) Patent Application Publication
(10) Pub. No.: US 2026/0137060 A1
(43) Pub. Date: May 21, 2026

(54) Two-piece Animal Garment With Integrated Self-Engaging Fabric for Continuous Adjustment

(71) Applicant: Shuangchun Zhan, Guangzhou (CN)

(72) Inventor: Shuangchun Zhan, Guangzhou (CN)

(21) Appl. No.: 19/449,226

(22) Filed: Jan. 14, 2026

(30) Foreign Application Priority Data
Oct. 12, 2023 (CN) 2023227513335

(51) Int. Cl. A01K 13/00

(52) U.S. Cl. CPC A01K 13/006

(57) ABSTRACT

An adjustable animal garment includes a first garment piece configured to engage a neck region of an animal and a second garment piece configured to engage a torso region of the animal. The first and second garment pieces are detachably connectable by overlapping connecting regions formed from fabric-integrated self-engaging material. The connecting regions are configured to releasably engage over a selectable overlap area, thereby permitting continuous adjustment of garment length and fit without predefined fastening locations. The fabric-integrated engagement provides uniform flexibility across the overlapping region and improves conformability during wear. The garment pieces may be worn together or independently and may be adjusted to accommodate animals of different sizes and body proportions. Alternative releasable fastening arrangements may also be employed in certain embodiments.

### CROSS-REFERENCE TO RELATED APPLICATIONS

This application claims priority to PCT Application No. PCT/CN2024/123639, filed on Oct. 9, 2024, which claims priority to Chinese Patent Application No. 202322751333.5 filed on Oct. 12, 2023.

### BACKGROUND OF THE INVENTION

### 1. The Field of the Invention

The present invention relates to animal garments and wearable animal articles, and more particularly to adjustable animal garments employing fabric-based engagement interfaces to permit variable overlap and fit adjustment.

### 2. Background

Animal garments are widely used for a variety of purposes, including protection from environmental conditions, thermal insulation, post-operative recovery, behavioral calming, and containment. Such garments may be applied to domestic animals, particularly companion animals, to cover portions of the neck, torso, or limbs. In many applications, the garment is intended to apply gentle, distributed coverage or pressure while maintaining comfort during extended wear.

Most existing animal garments employ a one-piece construction or rely on discrete fastening mechanisms, such as buckles, snaps, elastic straps, or sewn-on hook-and-loop fastener strips, to secure the garment to the animal. While these approaches can provide basic adjustability, adjustment is typically limited to predefined fastening locations determined by the placement and length of the fastener components. As a result, achieving a precise fit across animals of different sizes, shapes, or body proportions often requires multiple garment sizes or compromises in fit.

Additionally, the use of discrete, add-on fastening elements introduces localized regions of increased stiffness, thickness, or rigidity within the garment. These regions can reduce conformability, create pressure discontinuities, or lead to discomfort during movement. In garments intended for calming or recovery applications, such localized rigid areas may detract from the desired uniform distribution of coverage or pressure. Accordingly, there remains a need for an animal garment architecture that enables fine-grained, continuous adjustability while maintaining uniform flexibility and comfort across the garment, without reliance on discrete fastening strips or fixed fastening points.

### SUMMARY

The present invention provides an adjustable animal garment that overcomes the limitations of conventional garment constructions employing discrete fastening elements. In accordance with the invention, the garment includes a first garment portion configured to engage a neck or shoulder region of an animal and a second garment portion configured to engage a torso region of the animal. The first and second garment portions are detachably connectable and may be used independently or in combination.

In contrast to existing garments that rely on sewn-on fastener strips or fixed fastening points, the first and second garment portions are configured to engage one another through fabric-integrated engagement regions. In some embodiments, the engagement regions are formed from self-engaging textile materials such that substantially the entire surface area of the engagement regions is capable of releasable engagement. As a result, the degree of overlap between the garment portions may be varied continuously, enabling fine-grained adjustment of garment length, fit, and tightness without reliance on predefined fastening locations.

By distributing the engagement functionality across the fabric surface itself, the disclosed garment maintains substantially uniform flexibility and thickness across the overlapping region. This configuration reduces localized stiff or rigid areas commonly associated with add-on fastening components and improves overall conformability to the animal's body. The resulting garment architecture facilitates improved comfort during movement and wear, while allowing a single garment configuration to accommodate animals of different sizes and body proportions.

In certain embodiments, the adjustable overlap between the garment portions enables the garment to apply distributed coverage or pressure across selected regions of the animal's body. Such distributed engagement may be particularly advantageous in applications involving post-operative recovery, behavioral calming, or extended wear, where uniform contact and comfort are desired. The invention thus provides a structurally efficient and adaptable garment solution that enhances both adjustability and wearability.

### BRIEF DESCRIPTION OF THE DRAWINGS

FIG. 1 illustrates an overall structure of the two-piece animal garment.

FIG. 2 illustrates the neck piece.

FIG. 3 illustrates the body piece.

FIG. 4 illustrates an alternative embodiment.

### DETAILED DESCRIPTION

The embodiments described herein are provided to enable those skilled in the art to make and use the invention and to illustrate representative implementations of the disclosed concepts. The drawings and description are not intended to limit the scope of the invention, which is defined by the claims, and features described in connection with one embodiment may be combined with features of other embodiments unless expressly stated otherwise.

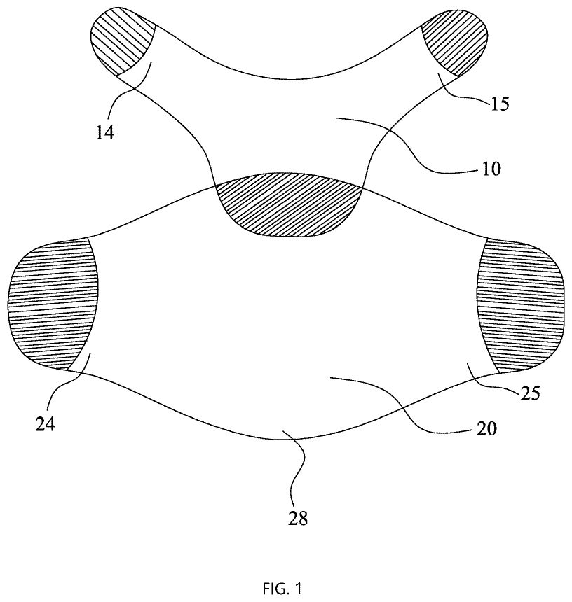

Referring to FIG. 1, the animal garment includes a first garment piece 10 and a second garment piece 20 configured to be selectively connected to one another. The first garment piece 10 includes a first main body portion 13 and a left strap 14 and a right strap 15 extending from left and right front portions of the first main body portion 13. The second garment piece 20 includes a second main body portion 23 with left and right side portions 24, 25 extending therefrom. When the first garment piece 10 and the second garment piece 20 are connected, the garment pieces overlap in a longitudinal direction such that a relative position between the garment pieces may be adjusted to accommodate animals of different sizes and body proportions.

Referring still to FIG. 1, the first garment piece 10 and the second garment piece 20 are configured to be detachably connected by overlapping engagement between corresponding connecting regions. In particular, the first garment piece 10 includes first connecting regions 16 and 17 disposed at front ends of the left strap 14 and the right strap 15, respectively, and the second garment piece 20 includes a corresponding connecting region 22 disposed at a forward portion of the second main body portion 23. The connecting regions 16, 17, and 22 are configured to overlap and releasably engage with one another over a selectable overlap area, thereby permitting adjustment of a relative position between the first garment piece 10 and the second garment piece 20.

In the illustrated embodiment, the connecting regions 16, 17, and 22 are formed from fabric-integrated self-engaging material, such that engagement functionality is distributed across the fabric surface of the connecting regions rather than being provided by discrete, sewn-on fastening elements. Substantially the entire surface area of each connecting region 16, 17, and 22 is capable of releasable engagement with a corresponding connecting region, thereby allowing the overlap area between the first garment piece 10 and the second garment piece 20 to be selected freely along a continuous range. As a result, adjustment of garment length and fit is not limited to predefined fastening locations, and the overlapping region maintains substantially uniform flexibility and thickness during engagement. This adjustability allows the garment to conform to animals of different sizes and body proportions using a single garment configuration, and enables the garment to maintain consistent contact during movement without requiring repositioning of the garment pieces.

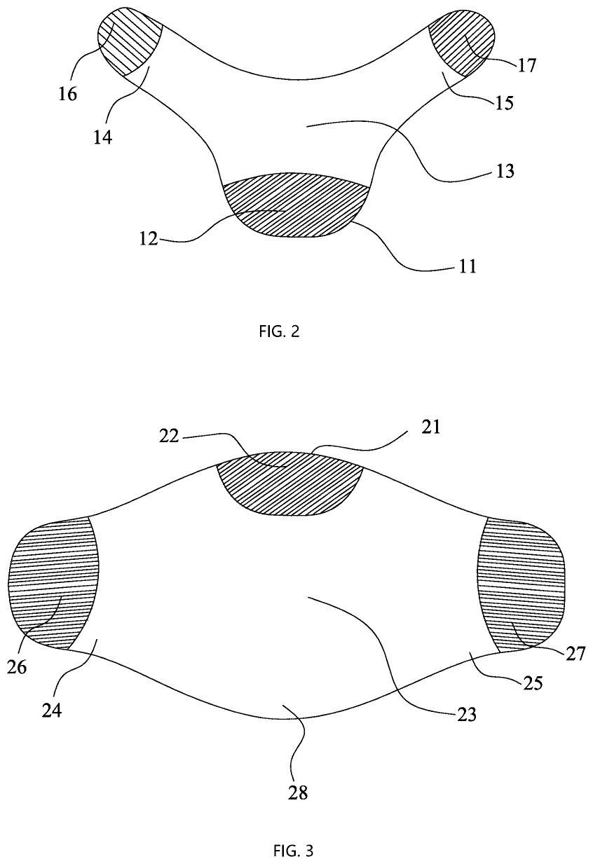

Referring to FIG. 2, the first garment piece 10 is configured to be positioned around a neck region of the animal. The first main body portion 13 is sized to extend along a rear or lateral portion of the neck, while the left strap 14 and the right strap 15 are configured to extend forward along opposite sides of the neck toward a front neck region. The arrangement of the first garment piece 10 allows the neck region to be encircled in a wrap-around manner while permitting adjustment of the extent to which the left strap 14 and the right strap 15 overlap at the front of the neck.

Referring to FIG. 3, the second garment piece 20 is configured to be positioned over a torso region of the animal. The second main body portion 23 is arranged to extend along a back region of the animal, while the left and right side portions 24 and 25 are configured to extend downward along opposite sides of the torso. The second garment piece 20 may be secured around the torso in a wrap-around configuration, allowing the garment to conform to the body shape of the animal while maintaining the forward connecting region 22 in a position suitable for engagement with the first garment piece 10.

When the first garment piece 10 and the second garment piece 20 are worn together, the relative positioning of the connecting regions allows the neck region and torso region of the animal to be engaged in a coordinated manner. The adjustable overlap between the garment pieces permits the garment to accommodate changes in posture and movement of the animal while maintaining consistent relative positioning between the neck-engaging and torso-engaging portions. This cooperative interaction reduces relative shifting between the garment pieces during use and helps maintain the intended fit over time.

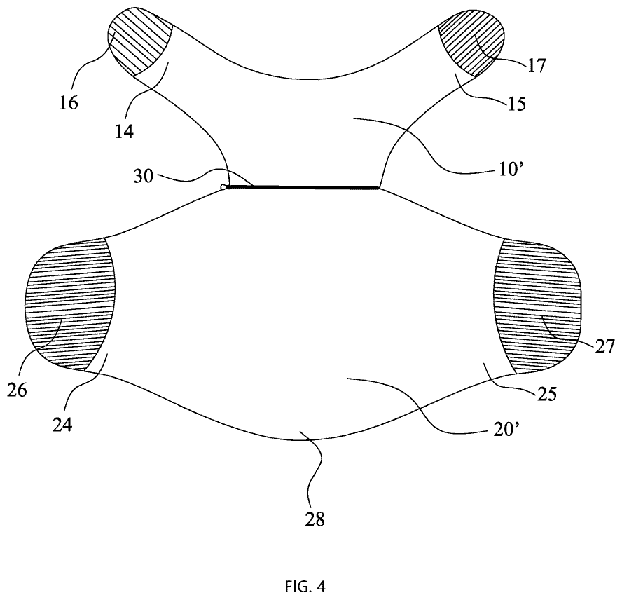

Referring to FIG. 4, an alternative embodiment of the animal garment is illustrated in which the overall shape, proportions, or arrangement of the first garment piece 10 and the second garment piece 20 differ from those shown in FIGS. 1-3. In this embodiment, the locations, sizes, or contours of the connecting regions may be varied to accommodate different animal anatomies or garment applications, while retaining the ability of the garment pieces to overlap and releasably engage over a selectable area. The illustrated alternative embodiment demonstrates that the described garment architecture is adaptable to different configurations without departing from the principles described herein.

In some implementations, the first garment piece 10 and the second garment piece 20 may be used independently of one another. For example, the first garment piece 10 may be worn alone to engage the neck region of the animal, or the second garment piece 20 may be worn alone to engage the torso region. In further embodiments, one or more of the connecting regions described herein may include alternative releasable fastening structures in addition to, or in place of, fabric-integrated self-engaging material. Such alternative fastening structures may include sewn-on hook-and-loop fastener strips, snap fasteners, buttons, or other releasable fastening elements, provided that the garment pieces remain detachably connectable and adjustable relative to one another. These embodiments may be suitable for applications in which discrete fastening locations are acceptable or desired.

Although the invention has been described primarily with reference to fabric-integrated self-engaging connecting regions that permit continuous adjustment over a selectable overlap area, the invention is not limited to such embodiments. The various garment structures, engagement regions, and fastening arrangements described herein may be modified, substituted, or combined in different ways depending on the intended application. Features described in connection with one embodiment may be combined with features of other embodiments unless expressly stated otherwise. Modifications and variations will be apparent to those skilled in the art in view of the foregoing description, and the scope of the invention is defined by the claims that follow.

What is claimed is:

1. An animal garment comprising: a first garment piece configured to engage a neck region of an animal; a second garment piece configured to engage a torso region of the animal;
wherein the first garment piece includes at least one first connecting region and the second garment piece includes at least one second connecting region;
wherein the first and second connecting regions are formed from fabric-integrated self-engaging material configured to releasably engage one another over a selectable overlap area;
and wherein a relative position between the first garment piece and the second garment piece is adjustable by varying the overlap area, such that a length and fit of the animal garment are continuously adjustable.

2. The animal garment of claim 1, wherein substantially an entire surface area of each of the first and second connecting regions is capable of releasable engagement.

3. The animal garment of claim 1, wherein adjustment of the overlap area is not limited to predefined fastening locations.

4. The animal garment of claim 1, wherein the fabric-integrated self-engaging material maintains substantially uniform flexibility across the overlap area when engaged.

5. The animal garment of claim 1, wherein the first garment piece and the second garment piece are separable and independently wearable.

6. The animal garment of claim 1, wherein the fabric-integrated self-engaging material comprises complementary textile engagement structures integrated into a fabric body.

7. The animal garment of claim 6, wherein the textile engagement structures comprise hook-and-loop engagement elements integrated into the fabric body.

8. A method of fitting an adjustable animal garment to an animal, comprising:
positioning a first garment piece around a neck region of the animal;
positioning a second garment piece around a torso region of the animal;
overlapping a fabric-integrated self-engaging connecting region of the first garment piece with a fabric-integrated self-engaging connecting region of the second garment piece;
and releasably engaging the overlapping connecting regions over a selected overlap area to adjust a length and fit of the garment.

9. The method of claim 8, wherein the overlap area is selected from a continuous range of overlap positions.

10. The method of claim 8, further comprising adjusting the overlap area to accommodate movement of the animal while maintaining engagement between the garment pieces.

11. The method of claim 8, wherein the releasable engagement is achieved without discrete sewn-on fastening strips.

12. The method of claim 8, wherein the garment applies distributed contact across at least one of the neck region or the torso region of the animal.

13. The method of claim 8, further comprising disengaging and re-engaging the connecting regions to readjust fit without repositioning the garment pieces on the animal.

14. The method of claim 8, wherein the first garment piece and the second garment piece are worn together during a calming, recovery, or extended-wear application.

15. A garment component for an animal garment, comprising: a flexible fabric body sized to engage a portion of an animal; and a fabric-integrated self-engaging connecting region formed on the fabric body;
wherein substantially an entire surface area of the connecting region is configured to releasably engage a complementary fabric-integrated self-engaging connecting region of another garment component over a selectable overlap area.

16. The garment component of claim 15, wherein the connecting region is formed at an edge or end portion of the fabric body.

17. The garment component of claim 15, wherein the connecting region enables continuous positional adjustment relative to the complementary garment component.

18. The garment component of claim 15, wherein the fabric-integrated self-engaging connecting region comprises a textile-based engagement structure.

19. The garment component of claim 18, wherein the textile-based engagement structure comprises hook-and-loop engagement elements integrated into the fabric body.

20. The garment component of claim 15, wherein the fabric body is configured to be used as one of a neck-engaging garment piece or a torso-engaging garment piece.
